(19) United States
(12) Patent Application Publication
(10) Pub. No.: US 2026/0259176 A1
(43) Pub. Date: Sep. 3, 2026

(54) METHOD TO IMAGE WAFERS AND CHIPLET SYSTEMS USING ULTRASONIC ARRAYS

(71) Applicant: Geegah LLC, Ithaca, NY (US)

(72) Inventors: Serhan M. Ardanuc, Ithaca, NY (US); Justin Kuo, Ithaca, NY (US); Amit Lal, Ithaca, NY (US)

(73) Assignee: Geegah LLC, Ithaca, NY (US)

(21) Appl. No.: 19/136,113

(22) PCT Filed: Sep. 21, 2023
(86) PCT No.: PCT/US2023/033414

§ 371 Date: Jun. 5, 2025

Related U.S. Application Data
(60) Provisional application No. 63/408,723, filed on Sep. 21, 2022.

(51) Int. Cl. G01N 29/06; G01N 29/07; G01N 29/26; G01N 29/28

(52) U.S. Cl. CPC G01N 29/069; G01N 29/07; G01N 29/262; G01N 29/28; G01N 2291/011; G01N 2291/023; G01N 2291/02854; G01N 2291/0289; G01N 2291/106

(57) ABSTRACT

An ultrasonic transducer technology consisting of a CMOS integrated piezoelectric transducers, that is wafer bonded to a high voltage drive capable transistor technology. This technology can be arranged in single chip, full wafer, and single line of chips to image bonded wafers to obtained defect and metrology data from the interface between wafers.

### CROSS-REFERENCE TO RELATED APPLICATION

The present application relates and claims priority to U.S. Provisional Patent Application No. 63/408,723, filed Sep. 21, 2022, the entirety of which is incorporated by reference herein.

### GOVERNMENT FUNDING

N/A

### FIELD OF THE INVENTION

The present disclosure is directed generally to semiconductor metrology.

### BACKGROUND

In the field of semiconductor metrology, there is a great need for being able to image wafers. Optical microscopy is generally used for inspection and verification to look at surface features at any stage of semiconductor fabrication. Other tools, such as X-ray diffraction and ellipsometry, quantify thin film qualities and thickness. Other methods such as CT scanning allow wafers to be imaged in 3D by imaging x-ray scattering by features in the wafer itself.

Another critical case for the inspection of wafers and packaged devices is to see the quality of interfaces between two wafers and materials in general. If the wafers are offset or have delamination or an air bubble during bonding, the device yield can be affected and the integrity of the bonded wafer maybe weak enough to potentially catastrophically split apart and break causing damage to equipment. It is important to be able to image bonded wafers to identify the errors to prevent wafer processing failures and lower yield. Imaging metallized wafers that are bonded to each other is a challenge. When two wafers are bonded, with metalized areas being bonded, it is hard for optical imaging to be used to image the interface, as the photons in an optical beam cannot penetrate the metal layers on both wafers. X-Ray imaging can be used but typically doesn't have sufficient contrast, costly due to the need for x-ray sources, typically in a vacuum chamber, and is time-consuming as X-ray scanning requires capturing x-ray beams at defend angles and requires substantial calculation time to identify features.

Scanning acoustic microscopes (SAM) are commonly used to image defects in multilayer structures. In SAMs, ultrasonic pulses are coupled through a thin liquid layer through the wafer, and reflected pulses are recorded. A limitation of this imaging modality is the time required for scanning. A mechanical stage is needed to move from one scan point to another. The transit time of the ultrasonic pulses is usually much smaller than the time to move the stage. A few SAM tools have been developed where multiple transmit/receive modules are integrated and move in parallel. It is possible to increase the speed of conventional SAM tools by increasing the number of transmit/receive modules integrated on the moving stage. Even so, the multiplication of existing probes, which tend to be large and bulky, only increases the speed to several hours per wafer. Because of the size of the transducer size, the number of parallel imagers that can operate simultaneously can be limited.

Accordingly, there is a need in the art for a massively parallel approach to imaging wafers to increase the throughput of defect detection.

### SUMMARY

The present disclosure is directed to a method and instrument to image wafers and chiplet systems using ultrasonic arrays.

According to an aspect is an instrument comprising a plurality of chips each of which includes arrays of ultrasonic transducers, each transducer operating at frequencies>100 MHz.

According to an embodiment, the instrument further comprises a X/Y/Z/roll/pitch/tilt stage on which plurality of chips are adapted to be mounted.

According to an embodiment, the stage includes a fluidic delivery channel to place liquid at a spot on the chip to be imaged.

According to an embodiment, the stage is adapted to push against the liquid to a create a thin layer between the imager surface and the

[symbol]

According to an embodiment, the stage is adapted to move the imager chip across an object to be imaged.

According to an embodiment, the imager chip images the liquid thickness across the imaging area by measuring the reflection occurring at the time of reflection from the water interface.

According to an embodiment, the imager chip uses the reception of ultrasonic signals on neighboring pixels to determine the diffraction of a structure in the object being imaged.

According to an embodiment, the system uses the diffraction data to determine the size of defects between wafers bonded.

According to an embodiment, the stage is adapted to use the liquid depth data to apply forces to make the liquid layer as thin as possible, and us ethe measured liquid layer thickness in a calculation model to calculate the defect image.

According to an embodiment, the instrument further comprises an imaging chip, mounted on a second X/Y/Z/Roll/Theta/Pitch actuator placed at the bottom of the wafer to be imaged.

These and other aspects of the invention will be apparent from the embodiments described below.

### BRIEF DESCRIPTION OF THE DRAWINGS

The present invention will be more fully understood and appreciated by reading the following Detailed Description in conjunction with the accompanying drawings, in which:

FIG. 1 is a prior art cross-sectional schematic view of an array of ultrasonic transducers on a standard CMOS wafer with integrated electronics on a silicon substrate.

FIG. 2 is a schematic view of the XYZ scanning of a wafer, in accordance with an embodiment.

FIG. 3 is a schematic view of wafer scale interrogation of W2W bond samples, in accordance with an embodiment.

FIG. 4 is a schematic view of high voltage drivers for CMOS integrated transducers, in accordance with an embodiment.

### DETAILED DESCRIPTION OF EMBODIMENTS

The present disclosure describes a method and instrument to image wafers and chiplet systems using ultrasonic arrays.

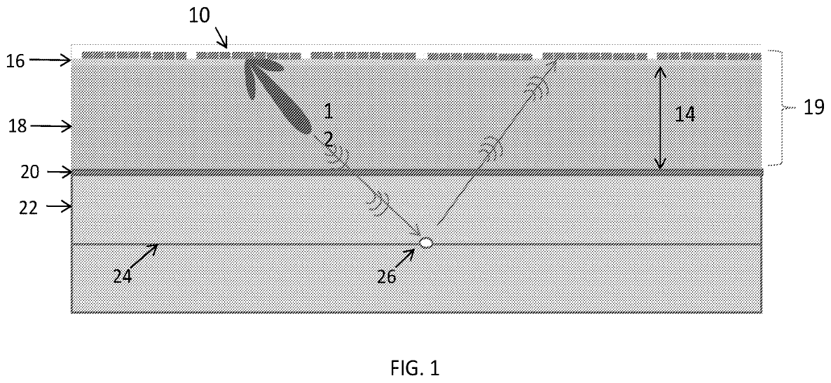

Applicant has previously demonstrated CMOS-integrated piezoelectric AlN transducers 10 that enable massively parallel arrays of ultrasonic pixels integrated within CMOS chips (FIG. 1). A top CMOS layer 16 is approximately 8-10 μm thick consisting of the transistors and wiring that rive the piezoelectric ALN transducers 10. The ultrasonic transducers launch waves into the silicon bulk 18 that can lead to a directional beam bent an at angle owing different delays and phases added to the drive transducers 10. The distance 14 is typically 300-600 μm thick which is 50-200 ultrasonic wavelengths in silicon at GHz frequencies. Hence, beam forming resulting in beam patterns 12 is possible. Applicant has imaged many objects using the CMOS integrated US array chips 19. A directional beam 12 can be launched that can pass through a thin coupling liquid layer 20 into a bonded wafer 22. A defect 26 between the bonded wafers 22 will create a different reflection than without the defect which can be imaged by the many transducers 10 in receive mode. Many objects placed on the backside of substrate 18 can be imaged as the object placed will reflect waves that are determined by the ultrasonic impedance difference between silicon and the object imaged. These objects include nematodes, fingerprints, soil texture and composition, bacteria imaging, silicon structures. The high-frequency operation enables very high-resolution, improving upon conventional SAM tolls running at lower frequencies. CMOS integrated transducers driven by integrated transducers can ne driven to 10 s of GHz owing to the very fast correct driving capabilities of deep-sub-micron CMOS transistor technologies.

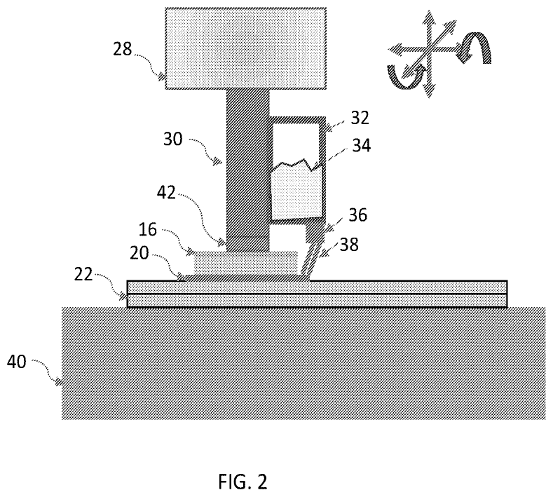

Scanning with CMOS Integrated Gigahertz Ultrasonic Transducer Imaging Chip: In this invention, applicant implements a system that can scan a wafer or a package at a much higher speed using ultrasonic imaging. The GHZ US imager chip can be mounted on an XYZ stage 28 such that it can be placed in proximity of the surface, the bonded wafer 22 placed on a XYZ stage 40, to be imaged (FIG. 2). The XYZ stage 28 can also have pitch, roll, and another motion axis to bring the imaging chip to proximity to the imager. A connecting bar can connect the stage to the imager chip, with a connecting adhesive 42 which has low ultrasonic impedance, such that the ultrasonic response is minimally affected by the connecting bar 30. A liquid delivery system is then used to dispense a thin drop of ultrasonic couplet liquid such as DI water or alcohols such as isopropanol (IPA). The delivery system can consist of a container 32, filled with liquids 34 such as water or IPA that evaporate fast and can be very clean without particles. IPA is preferred owing to speedy evaporation in comparison to water. The liquid delivery can be metered and delivered from one side using microvalve 36 with timed dosing through a small diameter pipe 38. The temperatures of the scanner area will be monitored to estimate the viscosity and ease of evaporation of the films during imaging. The wafer is then moved in a squeezing motion to push the liquid droplet across the wafer to prevent any air bubbles from forming by rocking the actuator back and forth. The wafer can be moved such that it starts with a tilt, a liquid droplet is placed, and the wafer is push while tilting to get a uniform thin layer of the liquid coupling layer. Active ultrasonic imaging of the liquid layer with the top imaging wafer and chip will allow the identification of any air bubbles in the liquid layer. The reflections of the ultrasonic waves across the thin liquid layer can be used to determine the layer thickness. The GHz ultrasonic imager has previously been used to image IPA and water layers evaporating and as the film and film thickness can be acquired by the modulation of the ultrasonic wave reflection coefficient.

The active imaging of the reflections of US waves from the liquid layer will enable monitoring of the liquid layer such that if the liquid starts evaporating on the sides, new fluid can be injected on the sides. The added liquid would wick due to surface tension. Once the liquid layer is stabilized, GHz frequency ultrasonic pulses can be used to transmit US pulses through the liquid layer into the wafer, and reflections are obtained from the interfaces. The reflected signal can be processed by gating the reflections at varying times to scan along the dimension perpendicular to the imaging plane. Due to diffraction of the ultrasonic pulses during travel in the bulk, upon reflections from defects and interfaces, some of the waves are expected to be received at nearby receiving pixels. By measuring the signals on the nearby pixels, the diffraction due to interface ultrasonic impedance changes will be measured, providing a way to see things using ultrasonic imaging that is not possible with scanning just a few transducers spaced far apart.

One of the challenges of imaging wafers and chips is the curvature in the wafer due to stress mismatches in the multiple layers. Due to the curvature a flat chip generates waves that are not equal across the scanning chip area. Further, in locations where there is an angle of the imaging surface with that of the wafer, waves can be launched such they diffract. The ability to measure the reflected waves at angles at neighboring pixels can identify curvature and eliminate the wafer curvature effects.

A second imaging chip can be used to scan the bottom of the wafer with the wafer being held on a platen ring. In this mode, ultrasonic pulses can be transmitted from the top imager chip and is transmitted to the bottom imaging chip. The combination of transmission images and reflection images will provide a detailed view of the wafer interfaces.

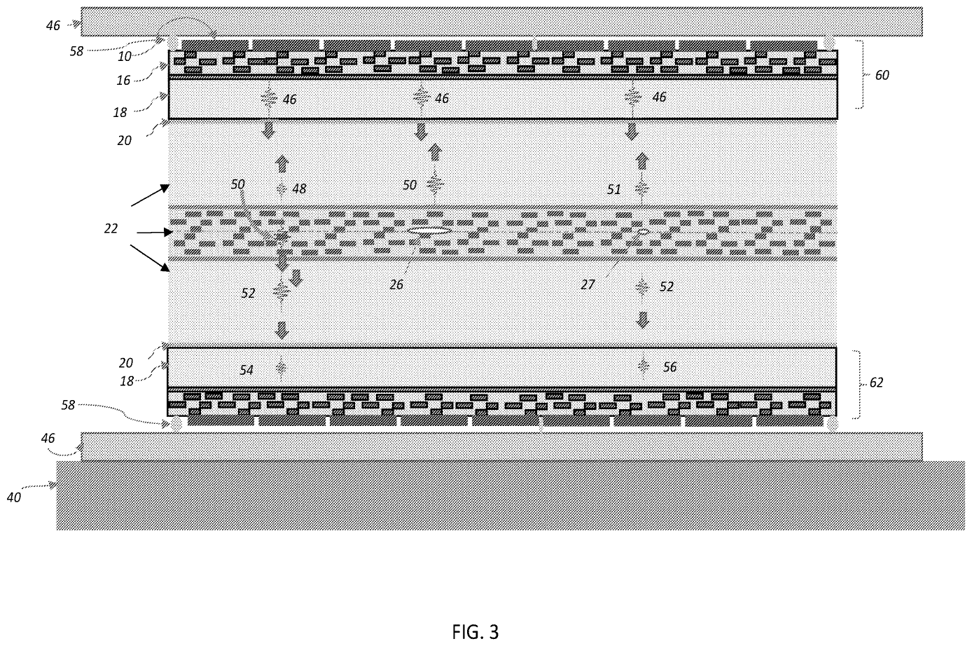

Wafer-scale imaging of wafers (FIG. 3): In this embodiment, a full CMOS wafer 60 consisting of ultrasonic imaging pixel array chips will be used to be brought in contact with the wafer to be imaged. The CMOS integrated transducers are fabricated on CMOS; hence, a full wafer full of imagers can be made and interconnected to be operated at once. A small fraction of space between imaging chips, defined byte size of the reticle used during lithography, cannot be populated with pixels, and there is a small percentage of a 2D imaging array chip that consists of control and drive/sense electronics that does not include active transducer. Furthermore, on the edges of the wafers many chiplets cannot be used as they cannot fit on a circular wafer. Hence, the imaging wafer will have areas that cannot be used for imaging. Hence, some amount of scanning of the imaging wafer will be required to image the wafer that is to be imaged. Nevertheless, this amount of scanning will be far less than needed by moving a few transducers or the imaging chip across the wafer. A second imaging wafer 62 can be placed at the bottom of the subject wafer to also record transmitted pulses. The imaging wafers 60 and 62 are packaged onto PCBs 46 though bonding that might include solder-ball 58 bonding. This second imaging wafer can be used to infer diffraction, and curvature of the wafer. If the wafer is curved, the top wafer gap will be less than the bottom wafer gap, enabling transmission though the top and bottom layers such that the average thickness of the liquid layer can be kept uniform across the wafer. US wave packets 46 are launched from the top imaging wafer, that transmit through liquid layer 20. The pulse packets will travel through the bonded wafer 22. The pulse 52 originates after traveling through the electronics at the bonded wafer interface undergoing diffraction in the area 50, resulting in a pulse packet 48 reflected. The pulse 52 travels through the coupling 20 and resulting pulse packet is detected at the bottom imaging wafer transducers. If there is a large air defect 26, then the incoming pulse packet 50 bounces back with high amplitude and is detected on top wafer. If a defect 27 is small, nearly equal pulses are transmitted and reflected, and lead to wave diffraction creating signals at far off pixels. The differential measurement provides further improvement in determining the location and size of defects at the interfaces. Note that some sections of this bonded wafer 22 and transmit/receive wafers 60/62 may not have any metallization in the center may serve as a way to calibrate the pulse packet transfer through the wafers. Specialized test metal pattern in the bonded wafer, such as diffraction gratings can be included at the interface to serve as a way to calibrate diffraction effects during imaging.

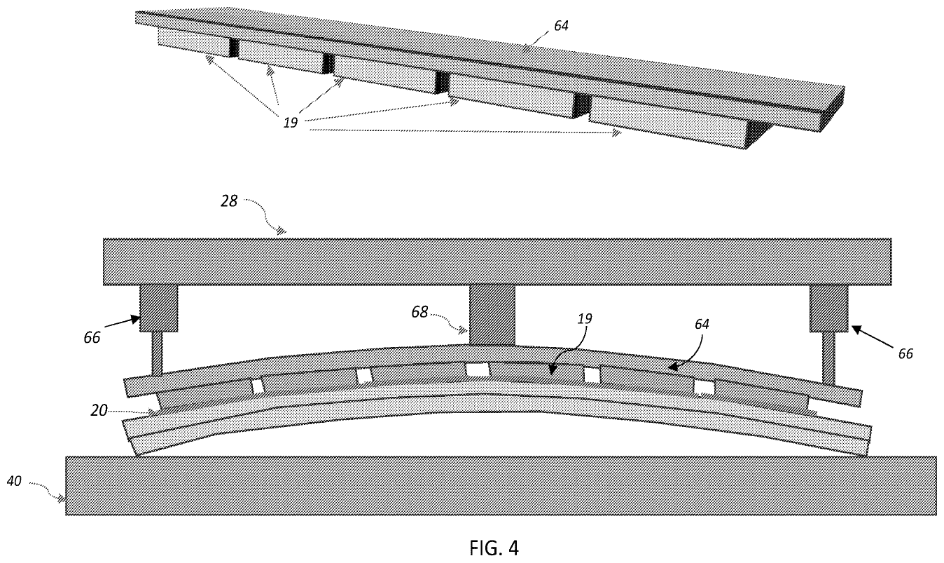

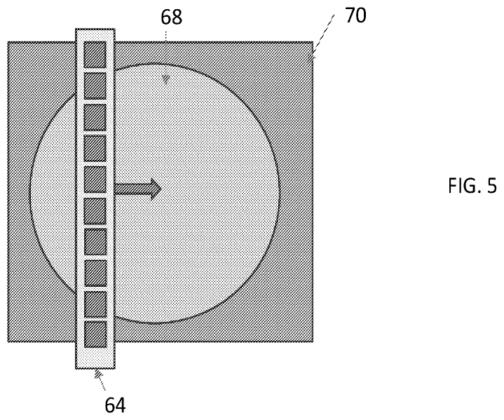

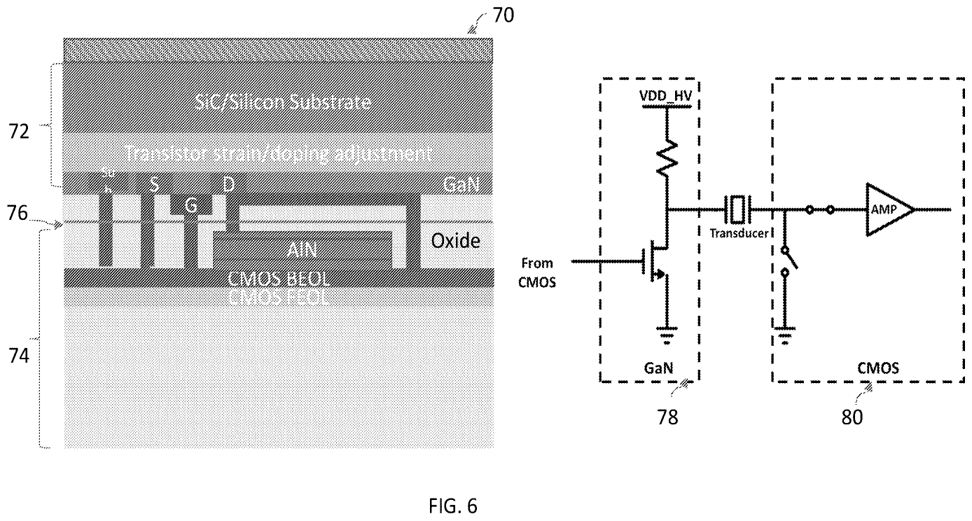

In some cases of imaging wafers, the wafer bow can be extreme. Instead of imaging with a 2D transducer array chip, or an entire wafer of an array of imaging chips, another embodiment is a line of imaging chips or transducer electronics (FIG. 4). The imaging chips or individual transducer chips are placed along a thin, slender bar 64, which can be a thin PCB. The line array can be mechanically scanned over the 68 resting on the wafer holding platen and XYZ stage 70 (FIG. 5). This approach can solve the curvature issue by enabling the linear array on a rectangular beam which is flexible such that it can bend to conform to the curved wafer surface. The width of the scanning beam will be thin enough to bend out-of-plane, and in-plane to form a conformable interface to the wafer. A set of actuators 66 on the xyz motion control stage 28 can be used to press or pull on the edges of the imaging beam to bend it to fit the curvature of the wafer. The liquid layer 20 thickness between the scanning beam of ultrasonic imager arrays and the wafer can be measured to provide feedback control signals to adjust the actuators to achieve intimate contact of the imaging beam. The

[symbol]

In the linear configuration of transducers on a thin flexible beam, the transducer array can be two pixels wide and hence tight integration with CMOS electronics may not be needed. In this case the chips 19 can only have piezoelectric transducers without integrated electronics. Off-chip COTS electronics can be used to drive a linear array of transducers. Further, this single line of transducers can be integrated with higher voltage drive electronics to measure the reflected signals at higher signal to noise ratio.

There is also a need to drive the transducers for imaging at high voltages to increase the SNR of the pulse-echo process. A modification of the ultrasonic imaging array chips is to use high voltage transistors integrated onto CMOS integrated transducer arrays (FIG. 6). In the transmit-receive pulses of the transducers described, a drive voltage RF pulse, generated by a pulse and amplifier chain, drives the piezoelectric transducer. The ultrasonic pulse then travels through the substrates and reflects to be sensed by piezoelectric transducers, followed by receive electronics chain. The return signal is directly proportional to the drive voltage. In CMOS, the operating voltages are limited to a few volts, and up to 15 or 20 V in special CMOS processes. To obtain higher drive voltage, we describe here a method to drive the piezoelectric transistors using high voltage capable GaN transistors. GaN transistors, and similarly SiC and other wideband gap transistors, can be operated at high voltages up to 100 s of volts with frequencies up to 10-50 GHz.

As see in FIG. 6, a top wafer containing high voltage transistors bonded to the CMSOS wafers with AlN transducers. The SiC/GaN wafer 72 consisting of layers of buffer layers are present to grow GaN layer. The source(S), drain (D), substrate (sub), and gate electrodes (G) are made in the GaN layer typically deposited by MBE or MOCVD deposition tools. Metal contacts to these transistor electrodes are made through an insulating layer made of insulating layers such as silicon dioxide. This top chip or wafer can be flip-chip bonded to the bottom CMOS wafer 74, and the contacts can be made in several ways such as metal reflow processes such as indium micro-scale bumping at the interface 76. The gate of the high voltage transistor 78 will be connected to the CMOS circuitry through wiring through the CMOS FEOL (front-end-of-the-line) layers such that the CMOS circuits can drive the high voltage transistor at the RF frequencies. The source terminal of the GaN transistor can be connected to the ground layer on top of the CMOS FEOL. The drain of the GaN transistor will be connected to the high VDD voltage through a load resistor formed in the CMOS on a top layer made of polysilicon or made on the GaN wafer using a semiconductive layer such as TiN or polysilicon. The connectivity to the GaN components will be done through the CMOS FEOL to reduce the complexity of the GaN wafer process. The transducer ground can be connected to ground or to an amplifier 80 through CMOS circuitry. The top chip can be bonded to the bottom CMOS chip at chip scale or at wafer scale. The electrical connections to the assembly will be made through the pads on the edges of the CMOS chips. If the top GaN is a full wafer, wafer etches will be used to access the pads through the SiC/GaN transistor layer. The back side of the SiC/Silicon wafer can be coated with an ultrasonic absorption layer 70, such as an epoxy loaded with metal particles, or thin films of metals such as copper and nickel, that are impedance matched. The absorption layer can absorb ultrasonic pulses that might reflect from the backside and interfere with signals coming from the reflections from the object being imaged. In this device the imaging can be setup on the top wafer surface or the bottom wafer bottom surface depending on where the absorption layer is placed. In FIG. 6, the imaging is assumed at the bottom layer and the top layer is absorbing any ultrasound.

While various embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

The above-described embodiments of the described subject matter can be implemented in any of numerous ways. For example, some embodiments may be implemented using hardware, software or a combination thereof. When any aspect of an embodiment is implemented at least in part in software, the software code can be executed on any suitable processor or collection of processors, whether provided in a single device or computer or distributed among multiple devices/computers.

What is claimed is:

1. An instrument comprising a plurality of chips each of which includes arrays of ultrasonic transducers, each of the transducers operating at frequencies greater than 100 MHz.

2. The instrument of claim 1, further comprising a X/Y/Z/roll/pitch/tilt stage on which a plurality of chips are adapted to be mounted.

3. The instrument of claim 2, wherein the stage includes a fluidic delivery channel to place liquid at a spot on the chip to be imaged and the instrument is adapted to generate liquid depth data.

4. The instrument of claim 3, wherein the stage is adapted to push against the liquid to a create a thin layer between the imager surface and the surface being imaged.

5. The instrument of claim 3, wherein the stage is adapted to move the imager chip across an object to be imaged.

6. The instrument of claim 1, wherein at least one of the plurality of chips image the liquid layer thickness across the imaging area by measuring the reflection occurring at the time of reflection from the liquid layer interfaces.

7. The instrument of claim 1, wherein at least one of the plurality of chips use the reception of ultrasonic signals on neighboring pixels and generate diffraction data by determining the diffraction of ultrasonic waves of a structure in the object being imaged.

8. The instrument of claim 7, wherein the imaging instrument is adapted to use the diffraction data to determine the size of defects between wafers bonded.

9. The instrument of claim 3, wherein the stage is adapted to use the liquid depth data to apply forces to make the liquid layer as thin as possible.

10. The instrument of claim 1, further comprising an imaging chip, mounted on a second X/Y/Z/Roll/Theta/Pitch actuator placed at the bottom of wafers to be imaged.

11. An imaging wafer comprising a plurality of sub areas, each of which comprises an ultrasonic imaging array of bulk-acoustic wave transducers formed with piezoelectric thin film, that has electrical interfaces to read out of the ultrasonic transmit/receive response of the transducers on the wafer.

12. The wafer in claim 11 further comprises aluminum nitride BAW transducers driven by integrated CMOS circuits.

13. The wafer in claim 11 further comprises aluminum scandium nitride transducers driven by CMOS circuits.

14. The wafer in claim 11 further comprises grooves to enable the wafer to bend onto a surface.

15. The wafer in claim 11, further comprises two layers, one is a CMOS wafer, and another wafer bonded on the CMOS wafer consisting of high voltage transistor technology.

16. The wafer in claim 15, where the high voltage transistors utilizing GaN transistors.

17. The wafer in claim 15, where the high voltage transistor technology is made of SiC transistors.

18. A rectangular beam consisting of ultrasonic transducer arrays consisting of bulk acoustic wave transducers, with the ability to bend to conform on another bent surface.

19. The beam of transducers in claim 18, consisting of CMOS integrated GHz ultrasonic transducer chips, with the ability to drive an electronic phased array to scan laterally to image an area even between the chips.

20. The beam of transducers in claim 18, consisting of CMOS integrated GHz ultrasonic transducer chips with high voltage drive transistor wafer which is heterogeneously bonded on top of the CMOS chips, with the ability to drive an electronic phased array to scan laterally to image an area even between the chips.

21. An instrument according to claim 1, further comprising a plurality of CMOS integrated chips each of which includes arrays of ultrasonic transducers, each of the transducers operating at frequencies greater than 100 MHz.
